(19) United States
(12) Patent Application Publication
(10) Pub. No.: US 2025/0199668 A1
(43) Pub. Date: Jun. 19, 2025

(54) SYSTEM AND METHOD FOR DISPLAYING MULTIPLE ITEMS

(71) Applicant: SAP SE, Walldorf (DE)

(72) Inventor: Francois DE BELEN, Le Chesnay-Rocquencourt (FR)

(21) Appl. No.: 18/542,016

(22) Filed: Dec. 15, 2023

(51) Int. Cl. G06F 3/04845; G06F 3/0485

(52) U.S. Cl. CPC G06F 3/04845; G06F 3/0485

(57) ABSTRACT

Disclosed herein are system, method, and computer program product embodiments for displaying items. An embodiment operates by receiving first data objects from a data store and a size of the first section for displaying first items, receiving a size of the display device for displaying first data items; determining a number of first data items to be displayed in the first section; determining a maximum first size for displaying one or more first items along the second axis in which scrolling along the second axis will not be necessary; determining whether the maximum first size exceeds a first threshold; in response to the determination that the maximum first size exceeds a first threshold, determining which portion of content from each first data object is to be displayed in each first data item; and providing for display the first data items in the first section.

### BACKGROUND

Computer applications can process hundreds and thousands of data objects and display results to a user on graphical user interface (GUI). In some circumstances, when there are many data objects whose associated visual representations are displayed on the GUI, a scrolling feature is provided that allows the user to scroll up and down, left and right, or both on a GUI so as to be able to see and interact with a particular visual representation of a data object or objects. If there are many such data objects, a substantial sub-set of visual representation of data objects cannot be displayed on the GUI at any one time and in such cases a scrolling feature can be used. However, scrolling through dozens, hundreds or thousands of visual representations of data objects on a GUI can be cumbersome.

### BRIEF DESCRIPTION OF THE DRAWINGS

The accompanying drawings are incorporated herein and form a part of the specification.

FIG. 1 illustrates an example system implementing mechanisms for providing display of multiple data items according to some embodiments of the disclosure.

FIG. 2 is a flow diagram that illustrates an exemplary process for providing display of multiple data items, according to some embodiments.

FIG. 3A depicts an example of a display of a process flow in accordance with implementations of the present disclosure.

FIG. 3B depicts an example of a display of a process flow in accordance with implementations of the present disclosure.

FIG. 4A illustrates a first example user interface for providing display of multiple data items on a display device, according to some embodiments.

FIG. 4B illustrates a second example user interface for providing display of multiple data items on a display device, according to some embodiments.

FIG. 5A illustrates a third example user interface for providing display of multiple data items on a display device, according to some embodiments.

FIG. 5B illustrates a fourth example user interface for providing display of multiple data items on a display device, according to some embodiments.

FIG. 6A illustrates a fifth example user interface for providing display of multiple data items on a display device, according to some embodiments.

FIG. 6B illustrates a sixth example user interface for providing display of multiple data items on a display device, according to some embodiments.

FIG. 7 illustrates a seventh example user interface for providing display of multiple data items on a display device, according to some embodiments.

FIG. 8 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for displaying multiple data items on a display device without scrolling. As described above, if there are many data objects, only a sub-set of associated data items can be displayed on the GUI at any one time and in such cases a scrolling feature can be used to navigate among the plurality of data items. However, scrolling through dozens, hundreds or thousands of data items on a GUI can be cumbersome. Therefore, a technological solution is needed to for displaying multiple data items on a display device without scrolling or with reduced amount of scrolling.

The technological solution in the present disclosure can provide a solution for displaying data items along a first axis and a second axis of a display device without scrolling or with reduced scrolling. A plurality of first data objects can be received from a data store. A size of the first section for displaying first data items can be received, where each first data item is associated with at least one first data object. A data item is a visual representation displayed on a display device where each data item is associated with one data object, multiple data objects or a portion of a data object. A plurality of first data objects can be received from a data store. A size of the display device for displaying first data items can be received. A number of first data items to be displayed can be determined in the first section. A maximum first size can be determined for displaying one or more first items along the second axis in which scrolling along the second axis will not be necessary. Whether the maximum first size exceeds a first threshold can be determined. In response to the determination that the maximum first size exceeds a first threshold, which portion of can be displayed from each first data object is to be displayed in each first data item can be determined. The first data items can be displayed in the first section. Alternatively, in response to the determination that the maximum first size does not exceed the first threshold, whether the maximum first size exceeds a second threshold can be determined. In response to the determination that the maximum first size exceeds a second threshold, the first data items can be displayed in the first section. Alternatively, in response to the determination that the maximum first size does not exceed the second threshold, an inverse of the maximum first size can be determined to represent that each of smallest allowable first data items on the display is represented on the display. The smallest allowable first data items can be displayed.

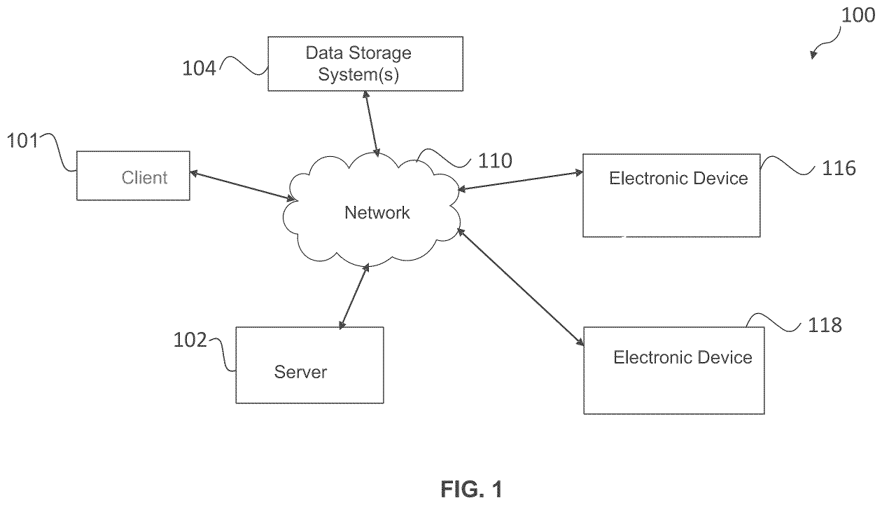

FIG. 1 illustrates an example system 100 implementing mechanisms for providing display of multiple data items according to some embodiments of the disclosure. The example system 100 is provided for the purpose of illustration only and does not limit the disclosed embodiments. The example system 100 may include, but is not limited to, a client device 101, a server 102, one or more data storage systems 104, a network 110, an electronic device 116, and electronic device 118.

In some aspects, electronic device 116 or electronic device 118 can include an Internet-of-things (IoT) device. As used herein, the term “IoT device” is intended to broadly encompass any device that is capable of engaging in digital communication with another device. For example, a device that can digitally communicate with another device can comprise an IoT device, as that term is used herein, even if such communication does not occur over the Internet. IoT devices may comprise a device such as, for example, a sensor, a smart phone, a laptop computer, a notebook computer, a tablet computer, a netbook, a desktop computer, a smart home device, and/or a wearable device. Still further, IoT devices may comprise an industrial IoT device, such as sensors and associated networking equipment that work together to collect, monitor, and analyze data from industrial operations. However, these are only examples and are not intended to be limiting.

In some aspects, server 102 may connect with of electronic device 116, and/or electronic device 118 via network 110. Alternatively or in addition, server 102 may connect to electronic device 116, and/or electronic device 118 via direct connections including, but not limited to, wired connections, internal connections, bus connections, virtual connections or other types of connections. In some aspects, server 102 can also connect with one or more classic computing systems that are not shown in FIG. 1.

In some embodiments, server 102 may include one or more application servers. One or more application servers can include a digital distribution platform for one or more applications. An application can include a software application designed to run on smartphones, tablet computers, smart device, smartwatch, wearable, internet of things (IoT) device, desktop computers and other electronic devices. Typically, an electronic device can offer an array of applications to a user. These applications may be free or purchased through an application store and installed at the user's electronic device. One or more application servers may include or be part of a distributed client/server system that spans one or more networks, for example, a local area network (LAN), wide area network (WAN), the Internet, a cellular network, or a combination thereof connecting any number of mobile clients, fixed clients, and servers. In some aspects, communication between client device 101 and server 102 can occur via a virtual private network (VPN), Secure Shell (SSH) tunnel, or other secure network connection.

In some aspects, one or more data storage systems 104 may include, but is not limited to, databases, data files, data sources, and the like. One or more data storage systems 104 can store data received from electronic device 116 and/or electronic device 118. Server 102 can retrieve data from one or more data storage systems 104, electronic device 116 and/or electronic device 118. Server 102 may connect with one or more data storage systems 104 via network 110. Alternatively or in addition, server 102 may connect to one or more data storage systems 104 via direct connections including, but not limited to, wired connections, internal connections, bus connections, virtual connections or other types of connections. In some aspects, server 102 can also connect with additional data storage systems that are not shown in FIG. 1. In some aspects, server 102 can include or be integrated with one or more data storage systems 104.

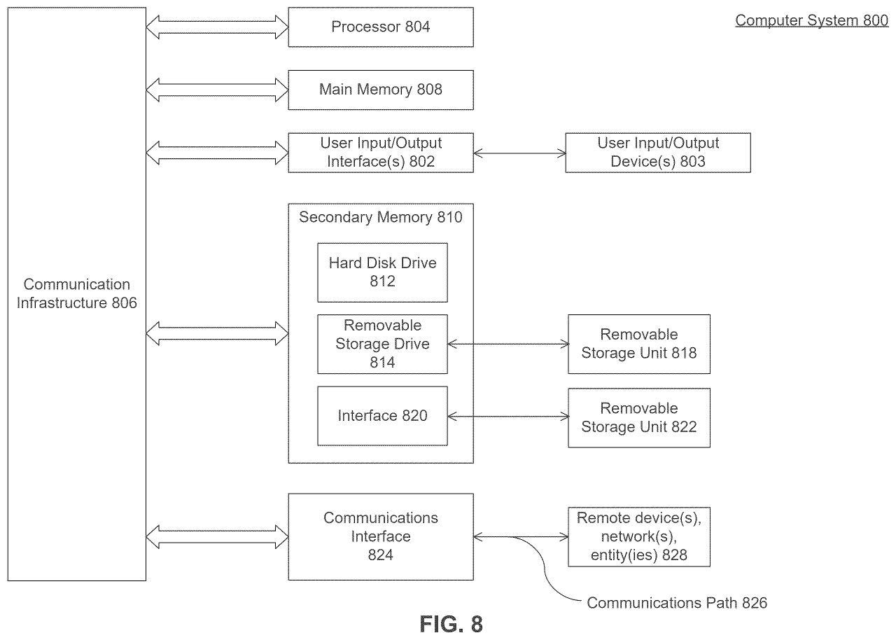

In some aspects, client device 101 may be configured to execute and operate a client application (e.g., a proprietary client application) that communicates with server 102 via the network 110. This way, client device 101 may access the various functionalities provided by server 102. Client device 101 may be the computer system 800 (see FIG. 8). Although the system 100 is shown with one client device 101, as would be appreciated by a person of ordinary skill in the art any number of client devices may be supported.

In some aspects, network 110 may be any type of network configured to facilitate data communications among client device 101, server 102, one or more data storage systems 104, electronic device 116, and electronic device 118 using any of a variety of network protocols. Network 110 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc. Network 110 may include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

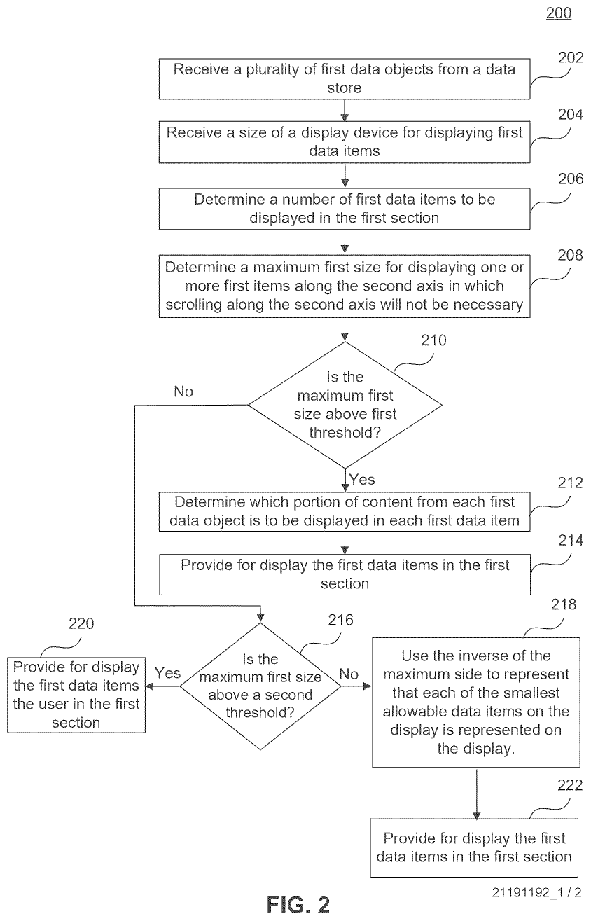

FIG. 2 illustrates an example method for providing a display of multiple data items, according to some embodiments. As a convenience and not a limitation, FIG. 2 may be described with regard to elements of FIGS. 1, 3A-3B, 4A-4B, 5A-5B, 6A-6B, 7 and 8. Method 200 may represent the operation of a computing system (e.g., server 102 of FIG. 1) for providing display of multiple data items. But method 200 is not limited to the specific aspects depicted in those figures and other systems may be used to perform the method as will be understood by those skilled in the art. It is to be appreciated that not all operations may be needed, and the operations may not be performed in the same order as shown in FIG. 2.

In 202, server 102 receives a plurality of first data objects from a data store (e.g., one or more data storage systems 104). In accordance with implementations of the present disclosure, the data store (e.g., one or more data storage systems 104) can host a database system that stores data objects. Each data object can contain one or more properties and a value or group of values associated with those properties. Typically the properties and values are together. As examples, a property could be labeled Last-Name and have a value assigned to it of “De Belen.” For other data objects associated with different people, the property Last-Name would have a value assigned to of “Smith.” In other examples, a property could be called Order and have different values (e.g., 7989, 9028, etc.) and a property entitled Job could be assigned different values (e.g., 030, 031, etc) for the data objects. Each value can be accessed using its property identifier or a more complex expression that refers to the data object. In addition, each data object can have a unique data type or a plurality of data types. In some examples, the client device 101 can interact with the database system to access data objects stored therein. For example, server 102 can interact with the database system to read data from, delete data from, add data to, and/or modify data within one or more data objects. The plurality of first data objects can be associated with a segment of a process, such as sub-process 302 as will be described below.

In 204, server 102 receives a size of a display device for displaying first data items. Depending on the implementation, each first data item is associated with only one data object, a portion of a data object, or a plurality of data objects or a portion of a plurality of data objects. A display device, such as a display device of client device 101, can have a first axis (e.g., x-axis or horizontal axis) and a second axis (e.g., y-axis or vertical axis).

In some aspects, display device may include a monitor, television (TV), computer, smart phone, tablet, wearable (such as a watch or glasses), appliance, internet of things (IoT) device, and/or projector, to name just a few examples. As is readily apparent, different devices have different sizes and can thus display more data items, more content of a particular data item or both. The first axis can be comprised of at least a first section and a second section. The first section can include section 402 as will be described below. The first section may be associated with a GUI of a segment of a process, such as sub-process 302 as will be described below. The size of the first section can include an amount of space along the first axis and an amount of space along the second axis. The size of the first section can be described in units of measure (e.g., millimeters or inches) or in pixels. The first data item can include a user interface element. A user interface element may include an input control, navigational and/or informational components. A user interface element may be displayed as one of the text fields, drop-down lists, buttons, menus, windows, check boxes, progress bars, or other visual elements.

In 206, server 102 determines a number of first data items to be displayed in the first section. In some implementations, this correlates to the results of a search or query. As an example, for a purchase order, a data field may be used to reduce the number of data objects responsive to the query (e.g., purchase orders received in September 2023). Thus, if the data store has thousands of data objects related to purchase orders, such a query may reduce the number of relevant data objects to a smaller number (e.g., 6) and thus at 206 it is determined that only 6 data items need to be displayed in the first section.

In 208, server 102 determines a maximum first size for displaying one or more first items along the second axis in which scrolling along the second axis will not be necessary. As an example, suppose the display device is the screen of a lap top computer that has a vertical axis of approximately 18 cm. If 6 data items are to be displayed along the vertical axis, each data item is allocated a maximum size or height of 3 cm. In contrast, if 4 cm were allocated to each data item, then only 4.5 out of 6 data items would be displayed on the screen at any one time whereby the user would have to scroll through the first section to view all of the data items. Thus, this determination can be achieved by division of a dimension of the first section by the number of data objects, and by correlation data items, responsive to a query. While the above example uses cm, it should be appreciated that other units of measure may also be used. For example, if the lap top screen has 1080 pixels along its vertical height, those 1080 pixels would be divided by 6 data items yielding a height of 180 pixels of height for each of the 6 data items (assuming there are no headers or additional information in each column). The maximum first size can be large enough to include content within the first data items, such as various property names and values retrieved from each respective data object. The maximum first size can also be associated with a smallest physical point on the display device. For example, the maximum first size can include a size of one pixel on the display device.

In 210, server 102 compares the maximum size calculated in 208 against a first threshold. The first threshold is set at an approximate value at which some content, such one or more property/value pairs, may be displayed in a data item and be legible to the user. Such a threshold could be set between 10-30 pixels. As an example, for 6 data items to be displayed across 1080 pixels, each data item would be 180 pixels along the second axis which is greater than a threshold set at 10 pixels (assuming no header or other information above or below the data items). In such a case, in 212, server 102 determines which portion of content from each data object is to be displayed in each data item. A hierarchy table can be consulted in which the various properties in a data object are ranked whereby the higher ranking properties and their corresponding values are displayed within each data item (e.g., order number is ranked higher than order date). In an alternative implementation, the user query used in 206 may set a default hierarchy of content to be displayed in each data item.

In 214, the data items are displayed to the user in the first section.

If in 210 the maximum size calculated in 208 is below the first threshold, then in 216 a comparison is done to determine if the maximum size calculated in 208 is above a second threshold. The second threshold may be set at the minimum amount of screen display that is visible or permissible on the display device. In one implementation, the second threshold may be a single pixel. As an example, suppose in 206 the number of responsive data objects to the query was 360 which yields a maximum height of 3 pixels per data item. This amount is deemed too small to provide any content (e.g., property/value pair) but can still be seen by the user as a single bar 3 pixels thick which is then displayed at 220.

If in 216 the maximum size calculated in 208 is below the second threshold (e.g. less than 1 pixel), then at 218 the inverse of the maximum size is used to represent that each of the smallest allowable data items on the display (e.g., a data item that is less than 1 pixel in height) is represented on the display. As an example, suppose the result of 206 yielded 2160 data objects such that the maximum size calculated in 208 is 0.5 pixels (below the second threshold used in 216). In 218 the inverse is taken such that the smallest displayable data item is correlated to more than one data object. In this example, a data item that is 1 pixel in height along the second axis, is representative of 2 data objects. Those data items are then displayed to the user in 222.

It should be noted that in describing the process of FIG. 2, a sufficient number of data items are displayed such that every requested data object has representation on the display without scrolling. The advantage of this will be described later.

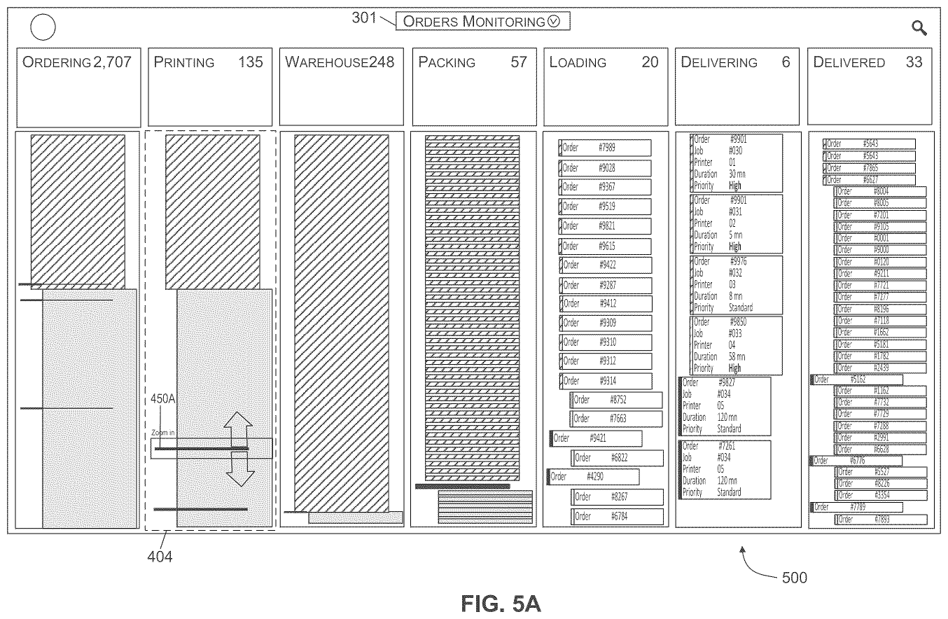

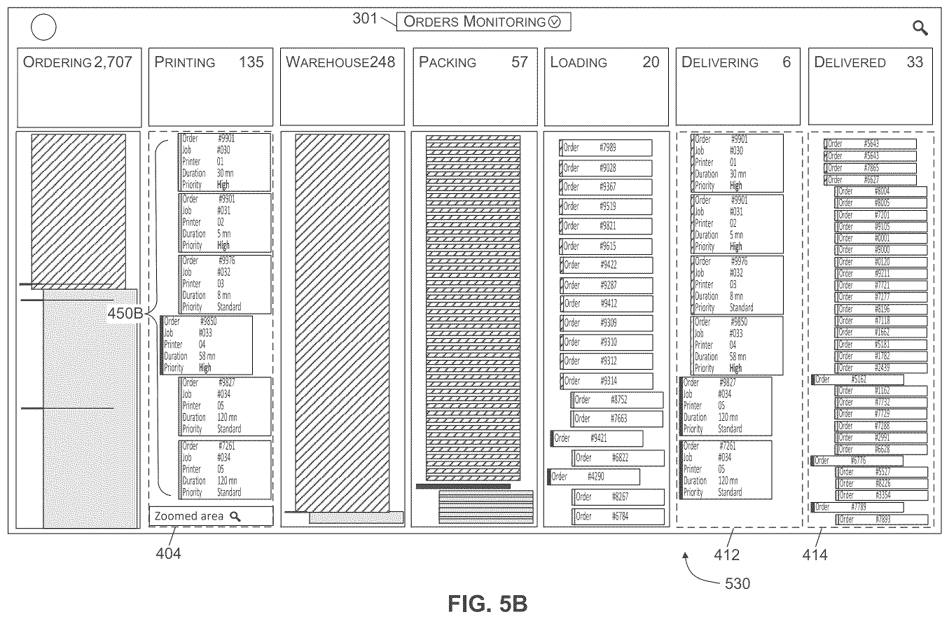

In some aspects, server 102 can receive a first input in the first section of the display device, such as a first user input to select a first item (e.g., item 450A in FIG. 5B) displayed in the first section. Server 102 can modify a size of the first item so as to increase the size of first item to include more content. Server 102 can provide for display content within the first item of the first size in the first section of the display device. For example, the size of item 450A can be increased to display as item 450B (in FIG. 5B) as will be described below. In addition, server 102 can receive a second input in the first section of the display device, subsequent to the first input. The second input can include a second user input to select one of the first items with the first size (e.g., item 450B) in the first section. Server 102 can modify the first size of the first item to a second size. Server 102 can provide for display content within the first item of the second size in the first section of the display device.

In some aspects, server 102 can provide display of data items in the second section of the display device, using method 200. Server 102 can receive a plurality of second data objects from the data store. As described above, each data object can contain one or more properties and a value or group of values associated with those properties. Typically the properties and values are together. Depending on the implementation, each second data item is associated with only one data object, a portion of a data object, or a plurality of data objects or a portion of a plurality of data objects. A display device, such as a display device of client device 101, can have a first axis (e.g., x-axis or horizontal axis) and a second axis (e.g., y-axis or vertical axis).

The plurality of second data objects can be associated with the plurality of first data objects based at least on a process (e.g., process 301). Server 102 can receive a size of the second section for displaying second data items. The second section may be associated with a GUI of a segment of a process, such as sub-process 304 as will be described below. The second section can include section 404 as will be described below. The size of the second section can include a size in the first axis and/or a size in the second axis. The size of the second section can include a number of smallest physical points along the second axis on the display device. For example, the size of the second section can include a number of pixels along the y axis on the display device. The second item can include a user interface element as described above.

Server 102 can determine a number of second data items to be displayed in the second section, as described above similar to determining a number of first data items to be displayed in the first section. In some implementations, this correlates to the results of a search or query. As an example, for a purchase order, a data field may be used to reduce the number of data objects responsive to the query (e.g., purchase orders received in September 2023). Thus, if the data store has thousands of data objects related to purchase orders, such a query may reduce the number of relevant data objects to a smaller number (e.g., 1608) and thus it is determined that only 1608 data items need to be displayed in the section.

Server 102 can determine a maximum second size for displaying one or more second items along the second axis in which scrolling along the second axis will not be necessary using. Similar to the maximum first size, the maximum second size can be large enough to include content within the second data items, such as various property names and values retrieved from each respective data object. The maximum second size can also be associated with a smallest physical point on the display device. For example, the maximum second size can include a size of one pixel on the display device. Server 102 can compare the maximum second size against a third threshold. The third threshold may be set at an approximate value at which some content, such one or more property/value pairs, may be displayed in a data item and be legible to the user. Such a threshold could be set between 10-30 pixels. The third threshold may be same or different from the first threshold. Server 102 can determine which portion of content from each data object is to be displayed in each data item. A hierarchy table can be consulted in which the various properties in a data object are ranked whereby the higher ranking properties and their corresponding values are displayed within each data item (e.g., order number is ranked higher than order date). In an alternative implementation, the user query may be used to set a default hierarchy of content to be displayed in each data item. The data items are displayed to the user in the second section.

If the maximum second size is below the third threshold, then a comparison is done to determine if the maximum second size is above a fourth threshold. The fourth threshold may be set at the minimum amount of screen display that is visible or permissible on the display device. In one implementation, the fourth threshold may be a single pixel. The fourth threshold may be the same as the second threshold. If the maximum second size is below the fourth threshold (e.g. less than 1 pixel), then the inverse of the maximum second size is used to represent that each of the smallest allowable data items on the display (e.g., a data item that is less than 1 pixel in height) is represented on the display. The inverse is taken such that the smallest displayable data item is correlated to more than one data object. Those data items are then displayed to the user in the second section. In some aspects, server 102 can provide for display a plurality of second items 442A-N as will be described below.

In some aspects, process 301 can include a state, such as one of 302A2, 304A2, 306A2, 308A2, 310A2, 312A2, and 314A2 as will be described below. Server 102 can determine at least one first data object associated with the state. Server 102 can provide for display a first data item with the state. The first data item can correspond to the at least one first data object. Server 102 can determine at least one second data object associated with the state. Server 102 can provide for display of a second data item with the state. The second data item corresponds to the at least second data object. The first data item can include item 440D as will be described below. The second data item can include item 442E as will be described below. In some aspects, the first axis can be comprised of a third section different from the first section and the second section. The third section can include section 418 as will be described below. Server 102 can determine a third data item associated with the state. The third data item can include item 446 as will be described below. Server 102 can receive a third input to select one of the first data item or the second data item. Server 102 can provide for display the third data item in the third section of the display device. The third data item can be associated with the at least one first data object, the at least one second data object, and the state. Server 102 can determine a fourth data item associated with the state and the process. Server 102 can display the fourth data item in the third section of the display device. The fourth data item can include item 470 as will be described below. Server 102 can receive a fourth input associated with the fourth data item to modify process 301 based at least on the state.

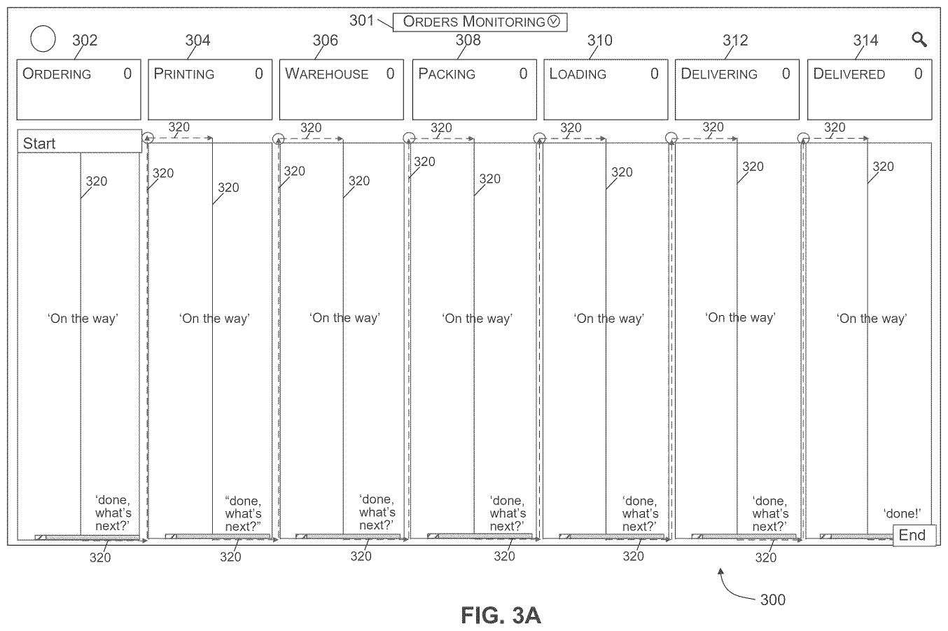

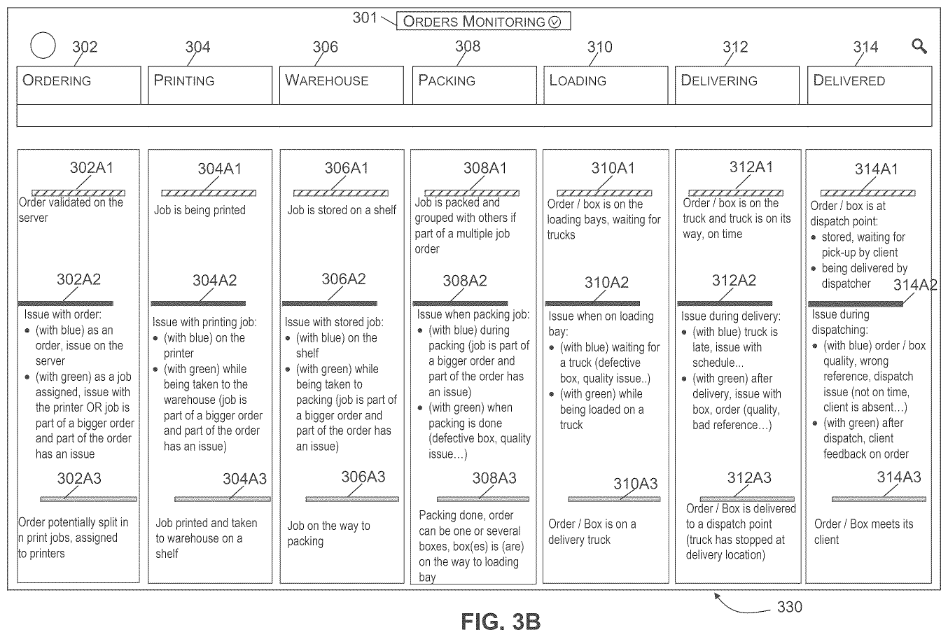

FIG. 3A depicts an example flow diagram of a process in accordance with implementations of the present disclosure. The example flow diagram 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3A, as will be understood by a person of ordinary skill in the art. The example flow diagram 300 shall be described with reference to FIGS. 1-2. The example flow diagram 300 is provided for the purpose of illustration only and does not limit the disclosed embodiments.

As shown in FIG. 3A, the example flow diagram 300 illustrates a flow diagram of a process 301, such as a business process related to a printing company. Process 301 includes a sub-process 302, a sub-process 304, a sub-process 306, a sub-process 308, a sub-process 310, a sub-process 312, and a sub-process 314.

Process 301 may start with sub-process 302. Process 301 may continue with sub-process 304 subsequent to sub-process 302, sub-process 306 subsequent to sub-process 304, sub-process 308 subsequent to sub-process 306, sub-process 310 subsequent to sub-process 308, sub-process 312 subsequent to sub-process 310 and sub-process 314 subsequent to sub-process 312. Each of sub-process 302, sub-process 304, sub-process 306, sub-process 308, sub-process 310, sub-process 312, and sub-process 314 may include a segment of the process. During each of sub-processes 302-312, data objects, such as data associated with each of sub-processes 302-312 may be generated and/or collected by one or more electronic devices (e.g., electronic devices 116 and 118). The data objects may be transmitted to and/or stored, for example, in server 102 and/or one or more data storage systems 104.

As shown in FIG. 3A, the example flow diagram 300 shows a path 320 of one order in process 301 through ordering, printing/production, warehouse/storage, packing, loading and delivery flow, starting from sub-process 302 to ending with sub-process 314. Different statuses of each sub-process, such as “on the way”, “done, what's next?” or “end” may be displayed as shown in FIG. 3A.

FIG. 3B depicts an example state diagram of a process in accordance with implementations of the present disclosure. The example state diagram 330 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3B, as will be understood by a person of ordinary skill in the art. The example state diagram 330 shall be described with reference to FIGS. 1-3A. The example state diagram 330 is provided for the purpose of illustration only and does not limit the disclosed embodiments.

As shown in FIG. 3B, the example state diagram 330 illustrates states 302A1-A3, states 304A1-A3, states 306A1-A3, states 308A1-A3, states 310A1-A3, states 312A1-A3, and states 314A1-A3. Each of states 302A1-A3 can represent a state of the process during sub-process 302. Each of states 304A1-A3 can represent a state of the process during sub-process 304. Each of states 306A1-A3 can represent a state of the process during sub-process 306. Each of states 308A1-A3 can represent a state of the process during sub-process 308. Each of states 310A1-A3 can represent a state of the process during sub-process 310. Each of states 312A1-A3 can represent a state of the process during sub-process 312. Each of states 314A1-A3 can represent a state of the process during sub-process 314.

In some aspects, each of states 302A2, 304A2, 306A2, 308A2, 310A2, 312A2, and 314A2 can indicate an error state in a corresponding sub-process 302, 304, 306, 308, 310, 312, or 314. Each of states 302A1, 304A1, 306A1, 308A1, 310A1, 312A1, and 314A1 can indicate an initial state, such as to start process 301, in a corresponding sub-process 302, 304, 306, 308, 310, 312, or 314. Each of states 302A3, 304A3, 306A3, 308A3, 310A3, 312A3, and 314A3 can indicate a final state, such as an end of process 301, in a corresponding sub-process 302, 304, 306, 308, 310, 312, or 314.

Each of states 302A1-A3 may be assigned to one or more data objects associated with sub-process 302, based on contextual information associated with the data objects. Similar, each of states 304A1-A3, states 306A1-A3, states 308A1-A3, states 310A1-A3, states 312A1-A3, and states 314A1-A3 may be assigned to one or more data objects associated with a corresponding sub-process of sub-process 304, sub-process 306, sub-process 308, sub-process 310, sub-process 312, or sub-process 314, based on contextual information associated with the data objects. As an example, a data object can be created in the system representative of an order for printed documents. Such an order may have multiple parts such as one part for posters, one part for postcards and another part for flyers. Thus, in one example, a singular data object is created in which multiple sub-components or jobs are created. As the various component or jobs progress through the process from Ordering at 302 to Delivered at 314, various data items will be displayed in the various columns indicative of where in the process the particular job or order is as well as an indication of the state of that job or order within that column.

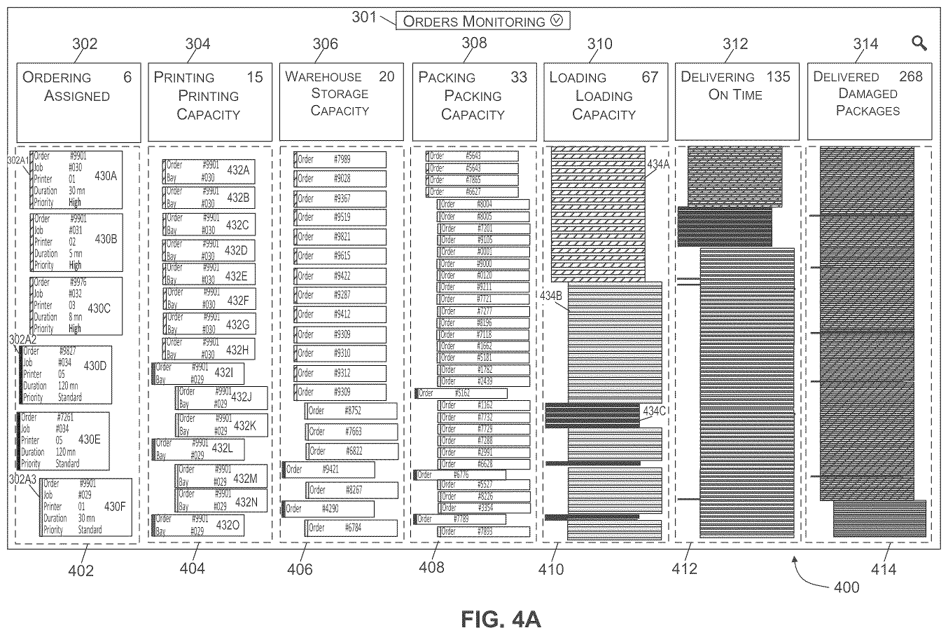

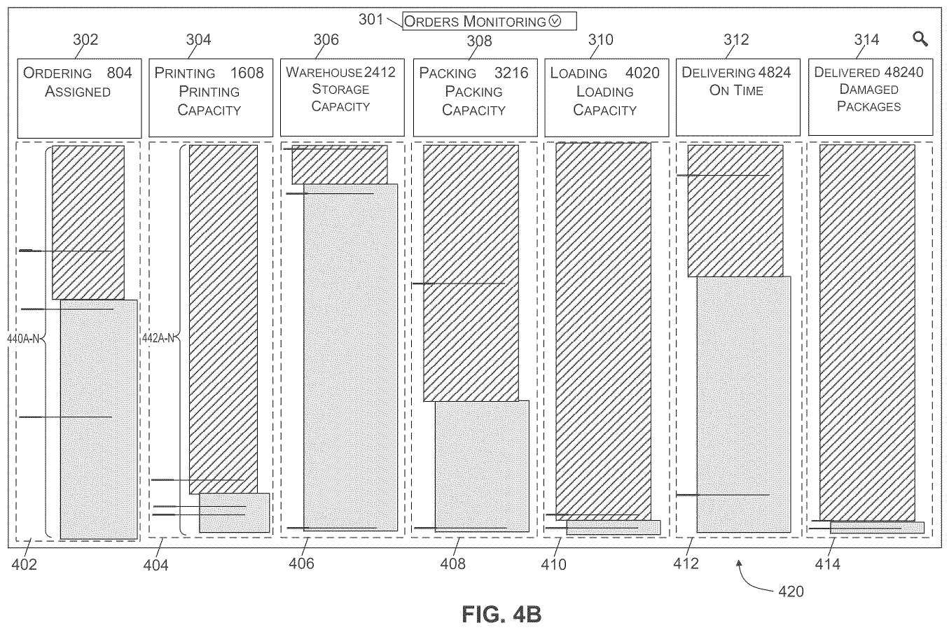

FIG. 4A illustrates a first example user interface for providing display of multiple data items on a display device, according to some embodiments. An application on a client device (e.g., client device 101) may output user interface 400. User interface 400 may be provided in association with a server (e.g., server 102 of FIG. 1, as described above) that can be a digital distribution platform for applications. However, user interface 400 is not limited thereto.

As shown in FIG. 4A, user interface 400 includes seven sections or columns, including section 402, 404, 406, 408, 410, 412, and 414. Section 402 displays six data items. Section 404 displays 15 data items. Section 406 displays 20 data items. Section 408 displays 33 data items. Section 410 displays 67 data items. Section 412 displays 135 data items. Section 414 displays 268 data items. One or more items in sections 402-414 can be displayed with a property, such as a list or a table. Each item can be displayed in different properties, shapes, colors, sizes, etc., as will be understood by a person of ordinary skill in the art.

Each of the sections 402, 404, 406, 408, 410, 412, and 414 can display data items associated with data objects that are in turn, and at various times, associated with a sub-process of process 301. In one example, section 402 can display first data items associated with a sub-process 302. Section 404 can display second data items associated with a sub-process 304. In one example, in each of section 402, 404, 406, 408, 410, 412, and 414, data items can be displayed based on a time during a corresponding sub-process of process 301. For example, a data item at the bottom of section 402 may be displayed as item 430F and associated with an earlier time during sub-process 402. A data item at the top of section 402 may be displayed as item 430A and associated with a later time during sub-process 402. As an example, in one implementation, as a business process progresses along, a representative data item associated with a data object can “move” up and down a column 402-414 as well as move across the display from column 402 to column 414.

As described above, each of states 302A1-A3 may be assigned to one or more data objects associated with sub-process 302. Similar, each of states 304A1-A3, states 306A1-A3, states 308A1-A3, states 310A1-A3, states 312A1-A3, and states 314A1-A3 may be assigned to one or more data objects associated with a corresponding sub-process of sub-process 304, sub-process 306, sub-process 308, sub-process 310, sub-process 312, or sub-process 314. The association of a data object to a state within a sub-process can be represented in association with the corresponding data item on the display of FIG. 4A.

A state assigned to a data object can be displayed as part of an item corresponding to the data object. In one example, in section 410, data items 434A are displayed with state 310A1. Data items 434B are displayed with state 310A2, to indicate an issue associated with sub-process 310. Data items 434C can be displayed in a red color, to indicate state 310A2 and an issue associated with sub-process 310. Item 434B is displayed with state 310A3. In another example, in section 402, data item 430A is displayed to include state 302A1 and other content. Item 430D is displayed to include state 302A2 and other content. Item 430F is displayed to include state 302A3 and other content. Each state can be displayed in different shapes, colors, highlighting, relative indentation (e.g. data items 434A in section 410 are visually more left justified within column 410 than data items 434B which are visually more right justified within column 410), etc., as will be understood by a person of ordinary skill in the art.

In each section of sections 402-414 of FIG. 4A, a first determination can be made for each section to display the data items accordingly. For instance, section 402 has six data items 430A-430F such that each data item is displayed with more content yet the height of each data item is determined such that all six data items are represented in that section. This can avoid the need for scrolling in section 402 along the y-axis. That is, the size of each display item and the content presented in each display item is scaled to provide sufficient content while allowing for all six data items to span substantially the entire height of section 402. In section 404, the display for each data item is smaller than in section 402. This can be achieved in multiple ways. In one example, data items 432A-O in section 404 can be smaller in size and some of the content displayed in section 402 is not displayed in section 404 for each data item (e.g., the data items in section 404 have less text than the data items in section 402). This can allow for all 15 data items to be represented in section 404 and span substantially the height of section 404. Section 406 has smaller display items compared to section 404 and again less content is shown in section 404 compared to section 406 to allow 20 data items to each represent a data object while also substantially spanning the height of section 406. In section 408, each display item is smaller than each display item in section 406, but the amount of content presented is the same in section 406 and section 408. In order to accommodate more data items, however, the font size, or image size or combination of both, in each data item is smaller in section 408 than it is in section 406. In section 410, no content is provided (e.g., no text or images in any of the displayed items) and the height of each item is reduced with respect to section 408 such that each individual item is shown as a bar. Again, the height of each bar can be determined such that each data object is represented in section 410 without scrolling in the y-axis and the data items substantially span the height of section 410. In one example, each bar can be displayed to represent different states of the corresponding data object using different shapes, colors, relative indentation etc., as will be understood by a person of ordinary skill in the art.

According to some aspects, user interface 400 may have less, more or different user interface elements than depicted in FIG. 4A. For example, user interface 400 may have a different number of columns or sections. In addition, the techniques described herein could also be applied to information displayed in rows and a combination of rows and columns. In some aspects, despite having different shapes, colors, sizes, etc., user interface 400 has the same or substantially the same functionality. That is, user interface 400 may enable a user to interact with a client device as discussed herein.

FIG. 4B illustrates a second example user interface for providing display of multiple items on a display device, according to some embodiments. An application on a client device (e.g., client device 101) may output user interface 420. User interface 420 may be provided in association with a server (e.g., server 102 of FIG. 1, as described above) that can be a digital distribution platform for applications. However, user interface 420 is not limited thereto.

As shown in FIG. 4B, user interface 420 includes seven sections or columns, such as including section 402, 404, 406, 408, 410, 412, and 414, same as in FIG. 4A. Each of the seven sections can display data items associated with data objects at various sub-process stage of process 301. For example, section 402 can display first data items associated with a sub-process 302. Section 404 can display second data items associated with a sub-process 304. As described above, in each section of sections 402-414 of FIG. 4A, a first determination can be made for each section to display the data items accordingly. In addition or alternatively, when the number of data items is significantly larger compared to FIG. 4A, a determination can be made for each section to display the data items accordingly, as shown in FIG. 4B. For example, data items 440A-N are displayed in section 402. Data items 442A-N are displayed in section 404.

In some aspects, a threshold can be determined such that the maximum display item height is the maximum height in which a data item has a level of visibility. As an example, the maximum height can be between 1 and 20 pixels on a display device (where 1 pixel height is the absolute smallest value for a maximum height). When the threshold is not achieved, as an example the height is determined to be 5 pixels based on the number of data items to be displayed in a column, the white space between each displayed item can be eliminated or not displayed, such that displayed items are shown as one block. This may occur when the number of responsive data objects, and thereby corresponding data items on a 1:1 association with the responsive data objects, can exceed the number of pixels on the screen in one dimension. For example, when there are 1080 pixels in one dimension and 2000 data objects, the height of 1 pixel for each data item (and by abstraction each data object) cannot be achieved so as to display each representative data item. Instead, each pixel height represents 2000/1080 or 1.85 data items and their corresponding data objects.

In some aspects, depending on the display device, the minimum height of 1 pixel may not include enough resolution to achieve a level of visibility on the display device. In some aspects, a minimum height of 20-40 pixels may include a minimum resolution to achieve a level of visibility on the display device. While the resolution between each individual item may be lost (e.g., no white space between each displayed data item), each data object can have a graphical representation on user interface 420 without the need for scrolling.

According to some aspects, user interface 420 may have less, more or different user interface elements than depicted in FIG. 4B. For example, user interface 420 may have a different number of columns or sections. In addition, the techniques described herein could also be applied to information displayed in rows and a combination of rows and columns. In some aspects, despite having different shapes, colors, sizes, etc., user interface 420 has the same or substantially the functionality. That is, user interface 420 may enable a user to interact with a client device as discussed herein.

FIG. 5A Illustrates a third example user interface for providing display of multiple data items on a display device, according to some embodiments. FIG. 5B illustrates a fourth example user interface for providing display of multiple data items on a display device, according to some embodiments. An application on a client device (e.g., client device 101) may output user interface 500 and/or 530. User interface 500 and/or 530 may be provided in association with a server (e.g., server 102 of FIG. 1, as described above) that can be a digital distribution platform for applications. However, user interface 500 and/or 530 are not limited thereto.

As described above in FIG. 4B, while the resolution between each individual item may not be achieved, each data object can have a graphical representation on user interface 420 without the need for scrolling. When data items are displayed in FIG. 4B, there may be a need for the user to apply a zooming action on a particular section.

As shown in FIG. 5A, for the Ordering column that has 2,707 responsive data objects and therefore 2,707 data items displayed therein, there is no resolution (e.g., whitespace) between the rows of pixels such that the data items are displayed as a continuous block. It should be noted that every one of the 2,707 data object/data item pairs is represented in the column. For the Printing column where there are 135 data object/data item pairs, a minimum height threshold is set for x pixels where X>1 (e.g. 20 pixels), but for 135×20 pixels yields 2,700 pixels which is greater than the pixel height of display 500. This results in no resolution between the individual data items such that the data items are again displayed as a continuous block. However, all 135 data object/data item pairs are represented in the column without the need for scrolling.

FIG. 5A shows such a zooming feature through a selection of a plurality of data items 450A on the display device. The selection can be based on a user input, such as a use of two fingers to select items 450A on a touch screen. The user may place two fingers relatively close together in a particular section and then separate those fingers while maintaining contact with the touch screen. The selection can also be based on other user input, such as clicking or pressing, superimposing a square over a section of a column, etc. associated with the data items 450. The selection can also be based on user input from one or more input devices, such as keyboards, pointing devices, remote controls and/or smart devices. The user input can be detected and size of the displayed items can be modified in the section to display content within the displayed items.

As shown in FIG. 5B, It should be noted that the zoom in function causes the Printing column to change so as to display 6 data items, but the total number of responsive data object/data item pairs of 135 is still shown in the column header so the user always sees the total number of responsive data objects regardless of the number and resolution of the displayed data items.

As shown in FIG. 5B, in response to the user input, a size of the plurality of data items 450A can be enlarged. Selected data items 450A can be displayed as enlarged data items 450B. In some aspects, data items 450A displayed near the approximate vertical center of section 404 can be determined to be in proximity to the center point between the two fingers placed onto the touchscreen by a user. Subsequent to displaying data items 450B, a scrolling function can be added to section 404 to allow the user to locate a particular item in section 404. As shown in FIG. 5B, the data items 450B can be displayed to a larger size to accommodate more content in a single zooming action. Alternatively, a first zooming action may only produce items with the minimum height in a section to include the minimum amount of content. To further increase the size of the items, additional zoom actions (e.g., fingers moving on a touchscreen) may be required. That is, a first zooming action may change the display of section 404 in FIG. 4B to the display of items of similar size to those displayed in section 414 of FIG. 5B. A subsequent zooming action can expand the individual items again to be of similar size to those displayed in section 412 of FIG. 5B.

According to some aspects, user interface 500 or 530 may have less, more or different user interface elements than depicted in FIG. 5A-5B. For example, user interface 500 or 530 may have a different number of columns or sections. In addition, the techniques described herein could also be applied to information displayed in rows and a combination of rows and columns. In some aspects, despite having different shapes, colors, sizes, etc., user interface 500 or 530 has the same or substantially the functionality. That is, user interface 500 or 530 may enable a user to interact with a client device as discussed herein.

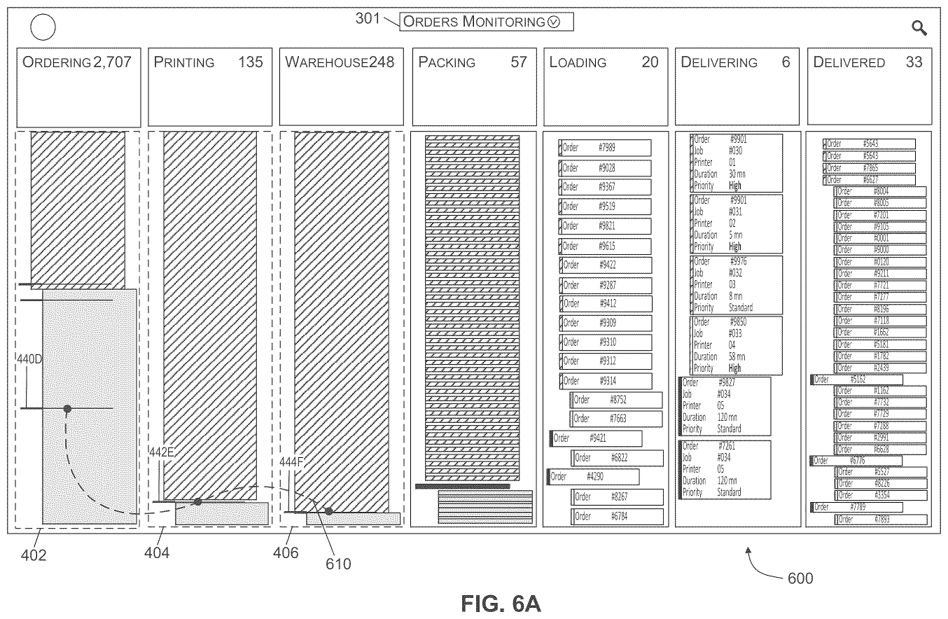

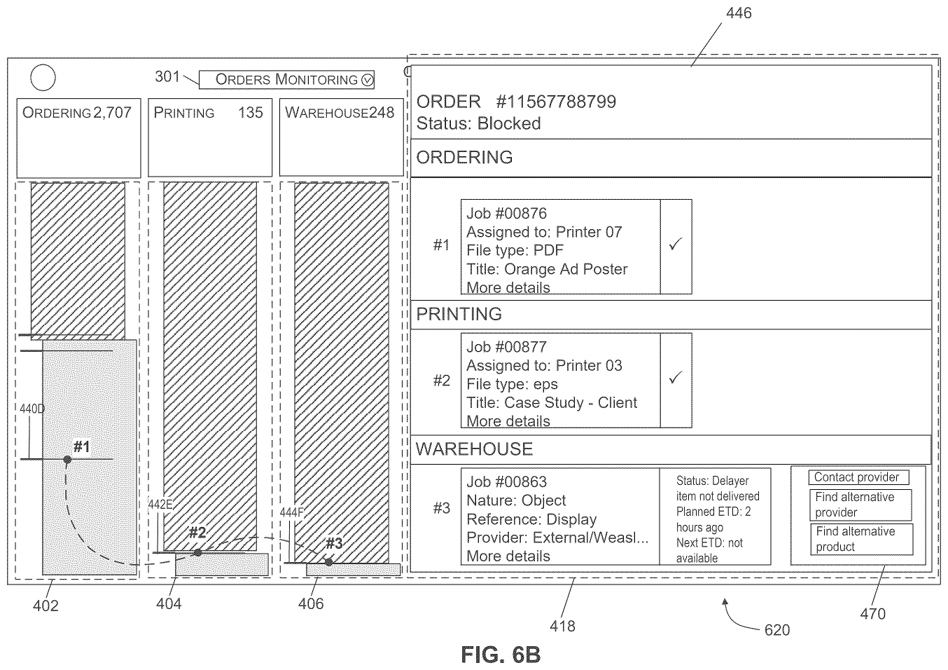

FIG. 6A illustrates a fifth example user interface for providing display of multiple data items on a display device, according to some embodiments. FIG. 6B illustrates a sixth example user interface for providing display of multiple data items on a display device, according to some embodiments. An application on a client device (e.g., client device 101) may output user interface 600 and/or 620. User interface 600 and/or 620 may be provided in association with a server (e.g., server 102 of FIG. 1, as described above) that can be a digital distribution platform for applications. However, user interface 600 and/or 620 are not limited thereto.

As described above, each of states 302A2, 304A2, 306A2, 308A2, 310A2, 312A2, and 314A2 can indicate an error state in a corresponding sub-process 302, 304, 306, 308, 310, 312, and 314. Each of states 302A1, 304A1, 306A1, 308A1, 310A1, 312A1, and 314A1 can indicate an initial state, such as to start a process, in a corresponding sub-process 302, 304, 306, 308, 310, 312, and 314. Each of states 302A3, 304A3, 306A3, 308A3, 310A3, 312A3, and 314A3 can indicate a final state, such as an end of a process, in a corresponding sub-process 302, 304, 306, 308, 310, 312, and 314.

As shown in FIG. 6A, item 440D is displayed with state 302A2 in section 402 to indicate an issue associated with sub-process 302. Item 442E is displayed with state 304A2, to indicate an issue associated with sub-process 304. Item 444F is displayed with state 306A2, to indicate an issue associated with sub-process 306.

In some aspects, state 302A2, 304A2, and 306A2 can be interconnected. For example, during process 301, an order can be made of several items coming from different sources and if one source fails, then the entire order can be blocked, delayed or it can show a risk of non-delivery. A path 610 can be displayed to illustrate the interconnectivity between state 302A2, 304A2, and 306A2. Path 610 can be displayed to trace the error states or data object/data item pairs associated with process 301. Path 610 can be displayed automatically or by being triggered by a user, such as through touch or keyboard filtering. A user may select path 610, or any of item 440D, 442E and 444F to request more information regarding the error states or items. A third and/or a fourth item can then be displayed in FIG. 6B.

As shown in FIG. 6B, a third item 446 is displayed in section 418 of the display device. Third item 446 can include a data object associated with one of the data items of 440D, a data object associated with a related data item within 442E, a data object associated with a related data item within data items 444F or state 302A2, 304A2, and 306A2. The origin of the error and additional information may be determined to be associated with the associated data item within data items 444F and displayed in section 418 of the display device. The additional information can include one or more solutions to fix the error (e.g., web links) and can be displayed as fourth item 470 in section 418 of the display device. The user may select fourth item 470 to modify the process based at least on the state.

According to some aspects, user interfaces 600 and 620 may have less, more or different user interface elements than depicted in FIG. 6A. For example, user interfaces 600 and 620 may have a different number of columns or sections. In addition, the techniques described herein could also be applied to information displayed in rows and a combination of rows and columns. In some aspects, despite having different shapes, colors, sizes, etc., user interfaces 600 and 620 have the same or substantially the functionality. That is, user interfaces 600 and 620 may enable a user to interact with a client device as discussed herein.

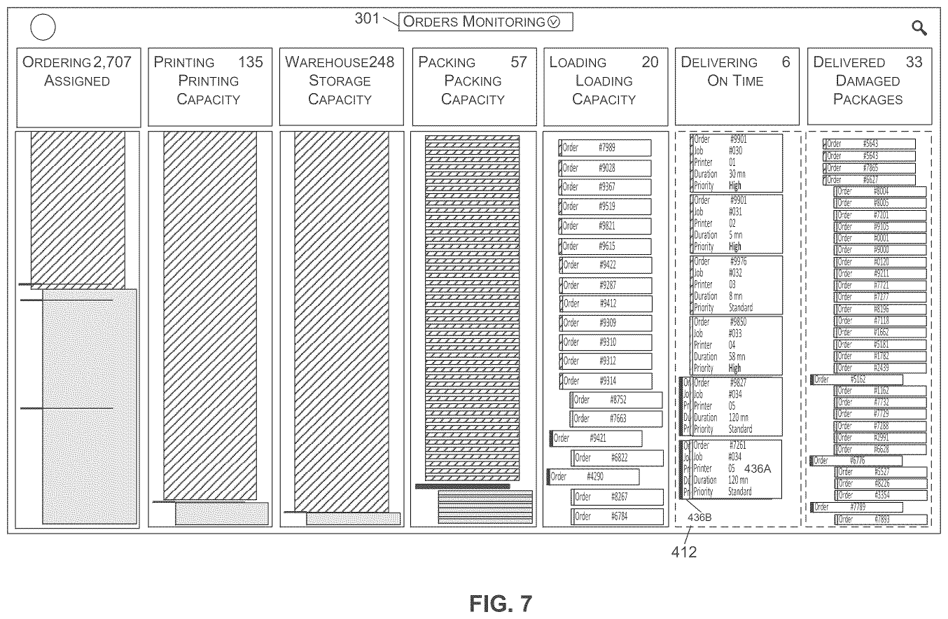

FIG. 7 illustrates a seventh example user interface for providing display of multiple items on a display device, according to some embodiments. An application on a client device (e.g., client device 101) may output user interface 700. User interface 700 may be provided in association with a server (e.g., server 102 of FIG. 1, as described above) that can be a digital distribution platform for applications. However, user interface 700 is not limited thereto.

As described above, in each of section 402, 404, 406, 408, 410, 412, and 414, data items can be displayed based on a time during a corresponding sub-process of process 301. As described earlier in conjunction with FIGS. 4A and 4B, a data item at the bottom of section 402 may be displayed as item 430F and associated with an earlier time during sub-process 402. A data object at the top of section 402 may be displayed as item 430A and associated with a later time during sub-process 402.

As shown in FIG. 7, in section 412, data item 436A is displayed to cover a portion of item 436B. A data object corresponding to display item 436A may be associated with an approximately same time as a data object corresponding to a display item 436B. In one example, data item 436B is displayed with state 312A2. State 312A2 can be visible and not covered by item 436A.

According to some aspects, user interface 700 may have less, more or different user interface elements than depicted in FIG. 7. For example, user interface 700 may have a different number of columns or sections. In addition, the techniques described herein could also be applied to information displayed in rows and a combination of rows and columns. In some aspects, despite having different shapes, colors, sizes, etc., user interface 700 has the same or substantially the functionality. That is, user interface 700 may enable a user to interact with a client device as discussed herein.

Various embodiments may be implemented, for example, using one or more well-known computer systems, such as computer system 800 shown in FIG. 8. One or more computer systems 800 may be used, for example, to implement any of the embodiments discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may further include a communication or network interface 824. Communication interface 824 may enable computer system 800 to communicate and interact with any combination of external devices, external networks, external entities, etc. (individually and collectively referenced by reference number 828). For example, communication interface 824 may allow computer system 800 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for displaying items along a first axis and a second axis of a display device, wherein the first axis is comprised of at least a first section and a second section, the computer-implemented method comprising:
receiving a plurality of first data objects from a data store;
receiving a size of the display device for displaying first data items;
determining a number of first data items to be displayed in the first section;
determining a maximum first size for displaying one or more first items along the second axis in which scrolling along the second axis will not be necessary;
determining whether the maximum first size exceeds a first threshold;
in response to the determination that the maximum first size exceeds a first threshold, determining which portion of content from each first data object is to be displayed in each first data item; and
providing for display the first data items in the first section, wherein at least one of the receiving, determining, and providing for display are performed by one or more computing systems.

2. The computer-implemented method of claim 1, wherein the maximum first size comprises a size of the display device along the second axis divided by the number of first data items.

3. The computer-implemented method of claim 1, wherein the first threshold is associated with a smallest physical point on the display device.

4. The computer-implemented method of claim 1, further comprising:
receiving a first input in the first section;
modifying a size of the first item to a first size, wherein the first item is associated with the first input; and
providing for display content within the first item of the first size in the first section.

5. The computer-implemented method of claim 4, further comprising:
receiving a second input in the first section;
modifying the first size of the first item to a second size, wherein the first item is associated with the second input; and
providing for display content within the first item of the second size in the first section.

6. The computer-implemented method of claim 1, further comprising:
receiving a plurality of second data objects from the data store;
receiving the size of the display device for displaying second data items;
determining a number of second data items to be displayed in the second section;
determining a maximum second size for displaying one or more second items along the second axis in which scrolling along the second axis will not be necessary;
determining whether the maximum second size exceeds a third threshold;
in response to the determination that the maximum second size exceeds the third threshold, determining which portion of content from each second data object is to be displayed in each second data item; and
providing for display the second data items in the second section.

7. The computer-implemented method of claim 6, further comprising:
in response to the determination that the maximum second size does not exceed the third threshold, determining whether the maximum second size exceeds a fourth threshold; and
in response to the determination that the maximum second size exceeds the fourth threshold, providing for display the second data items in the second section.

8. The computer-implemented method of claim 7, further comprising:
in response to the determination that the maximum second size does not exceed the fourth threshold, determining an inverse of the maximum second size to represent that each of smallest allowable second data items on the display is represented on the display; and
providing for display the smallest allowable second data items.

9. The computer-implemented method of claim 8, wherein the smallest allowable second data item is associated with a number of the second data objects, and wherein the number comprises the inverse of the maximum second size.

10. A computer-implemented method for displaying items along a first axis and a second axis of a display device, wherein the first axis is comprised of at least a first section and a second section, the computer-implemented method comprising:
receiving a plurality of first data objects from a data store;
receiving a size of the display device for displaying first data items;
determining a number of first data items to be displayed in the first section;
determining a maximum first size for displaying one or more first items along the second axis in which scrolling along the second axis will not be necessary;
determining whether the maximum first size exceeds a first threshold;
in response to the determination that the maximum first size does not exceed the first threshold, determining whether the maximum first size exceeds a second threshold; and
in response to the determination that the maximum first size exceeds a second threshold, providing for display the first data items in the first section, wherein at least one of the receiving, determining, and providing for display are performed by one or more computing systems.

11. The computer-implemented method of claim 10, wherein the maximum first size comprises a size of the display device along the second axis divided by the number of first data items.

12. The computer-implemented method of claim 10, wherein first threshold is associated with a smallest physical point on the display device.

13. The computer-implemented method of claim 10, further comprising:
receiving a first input in the first section;
modifying a size of the first item to a first size, wherein the first item is associated with the first input; and
providing for display content within the first item of the first size in the first section.

14. The computer-implemented method of claim 13, further comprising:
receiving a second input in the first section;
modifying the first size of the first item to a second size, wherein the first item is associated with the second input; and
providing for display content within the first item of the second size in the first section.

15. The computer-implemented method of claim 14, further comprising:
receiving a plurality of second data objects from the data store;
receiving the size of the display device for displaying second data items;
determining a number of second data items to be displayed in the second section;
determining a maximum second size for displaying one or more second items along the second axis in which scrolling along the second axis will not be necessary;
determining whether the maximum second size exceeds a third threshold;
in response to the determination that the maximum second size exceeds the third threshold, determining which portion of content from each second data object is to be displayed in each second data item; and
providing for display the second data items in the second section.

16. The computer-implemented method of claim 15, further comprising:
in response to the determination that the maximum second size does not exceed the third threshold, determining whether the maximum second size exceeds a fourth threshold; and
in response to the determination that the maximum second size exceeds the fourth threshold, providing for display the second data items in the second section.

17. The computer-implemented method of claim 16, further comprising:
in response to the determination that the maximum second size does not exceed the fourth threshold, determining an inverse of the maximum second size to represent that each of smallest allowable second data items on the display is represented on the display; and
providing for display the smallest allowable second data items.

18. The computer-implemented method of claim 17, wherein the smallest allowable second data item is associated with a number of the second data objects, and wherein the number comprises the inverse of the maximum second size.

19. A computer-implemented method for displaying items along a first axis and a second axis of a display device, wherein the first axis is comprised of at least a first section and a second section, the computer-implemented method comprising:
receiving a plurality of first data objects from a data store;
receiving a size of the display device for displaying first data items;
determining a number of first data items to be displayed in the first section;
determining a maximum first size for displaying one or more first items along the second axis in which scrolling along the second axis will not be necessary;
determining whether the maximum first size exceeds a first threshold;
in response to the determination that the maximum first size does not exceed the first threshold, determining whether the maximum first size exceeds a second threshold; and
in response to the determination that the maximum first size does not exceed the second threshold, determining an inverse of the maximum first size to represent that each of smallest allowable first data items on the display is represented on the display;
providing for display the smallest allowable first data items, wherein at least one of the receiving, determining, and providing for display are performed by one or more computing systems.

20. The computer-implemented method of claim 19, wherein the smallest allowable first data item is associated with a number of the first data objects, and wherein the number comprises the inverse of the maximum first size.
